(19) United States
(12) Patent Application Publication
(10) Pub. No.: US 2014/0008895 A1
(43) Pub. Date: Jan. 9, 2014

(54) BABY STROLLER WITH TRAY SUPPORT

(71) Applicant: PATRICK LEE, New Taipei City (TW)

(72) Inventor: PATRICK LEE, New Taipei City (TW)

(21) Appl. No.: 13/541,875

(22) Filed: Jul. 5, 2012

(51) Int. Cl. B62B 9/10

(52) U.S. Cl. 280/647

(57) ABSTRACT

A baby stroller includes a front frame and a rear frame, and the front and rear frames are connected to two connection units. A tray support is connected between the connection units. One of the connection units has a folding device which has a first positioning plate connected to the front frame and a second positioning plate connected to the rear frame. The first and second positioning plates respectively have first and second teeth which are respectively engaged with a front gear and a rear gear located in the connection unit. The front and rear gears are respectively engaged with each other. By the engagement between the first and second teeth and the front and rear gears, the baby stroller is folded by one hand.

### BACKGROUND OF THE INVENTION

1. Field of The Invention

The present invention relates to a baby stroller, and more particularly, to a baby stroller with a tray support and the baby stroller can be folded by one hand.

2. Brief Description of Prior Art

The conventional bay strollers each have only one specific function such as the conventional baby stroller does not have a proper device for positioning the trays for meals, or cannot used as car seats. Therefore, different functions of the strollers are required for a family so as to meet different needs of the babies. For instance, the baby needs a stroller that allows the baby to sleep and sit when the baby is outside of home. A cart with a tray support device is needed at home when having meals. A bed is needed when sleeping at home. The different baby needs occupy a lot of space.

The present invention intends to provide a baby stroller with a tray support which supports the tray for meals. The baby stroller is easily folded by one hand.

### SUMMARY OF THE INVENTION

The present invention relates to a baby stroller and comprises a front frame and a rear frame. The front and rear frames are connected to two connection units. A tray support is connected between the connection units. One of the connection units has a folding device which has a first positioning plate connected to the front frame and a second positioning plate connected to the rear frame. The first and second positioning plates respectively have first and second teeth which are respectively engaged with a front gear and a rear gear located in the connection unit. The front and rear gears are respectively engaged with each other. The first positioning plate has a first engaging recess and the second positioning plate has a second engaging recess. An operation member is received in the connection unit and located beneath the first and second positioning plates. The operation member has a rod which is engaged with the first and second engaging recesses.

By the engagement between the first and second teeth and the front and rear gears, the baby stroller is folded by one hand.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the baby stroller of the present invention;

FIG. 2 is a side view to show the baby stroller of the present invention;

FIG. 3 is an exploded view to show the folding device of the present invention;

FIG. 4 is a front cross sectional view of the folding device of the present invention;

FIG. 5 is the side view of the cable connected to the folding device;

FIG. 6 is the front view of the cable connected to the folding device;

FIG. 7 is a side cross sectional view of the folding device of the present invention;

FIG. 8 shows the tray support connected to the baby stroller of the present invention;

FIG. 9 shows that the baby stroller of the present invention is expanded;

FIG. 10 shows that the safety member is unlocked, and

FIG. 11 shows that the folding device is in folded status.

### DETAILED DESCRIPTION OF THE PREFERRED EMBODIMENT

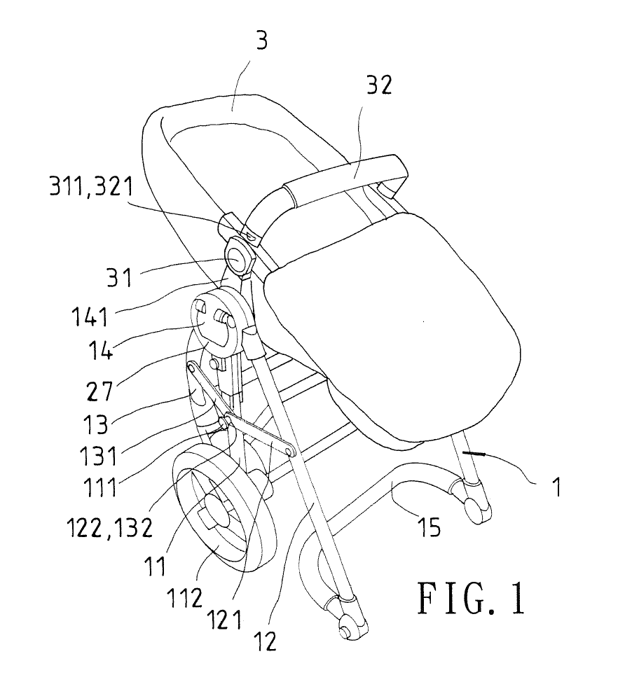

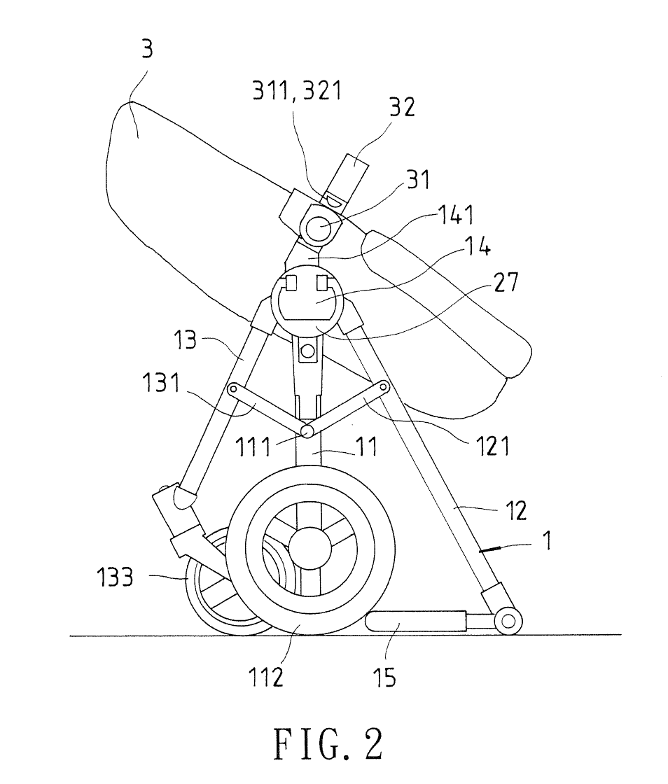

Referring to FIGS. 1 and 2, a baby stroller 1 of the present invention comprises a main frame 11, a folding device 2, a seat 3 and a tray support 4.

The main frame 11 comprises a front frame 12 and a rear frame 13. The front and rear frames 12, 13 are connected between two connection units 14. The front frame 12 and the rear frame 13 each have a link 121/131. Each of the links 121, 131 has a notch 122/132. The main frame 11 has pins 111 which are engaged with the notches 122, 132. Two wheels 112 are connected to two sides of the main frame 11 and two wheels 133 are connected to two sides of the rear frame 13. A handle 15 is connected to the front frame 12.

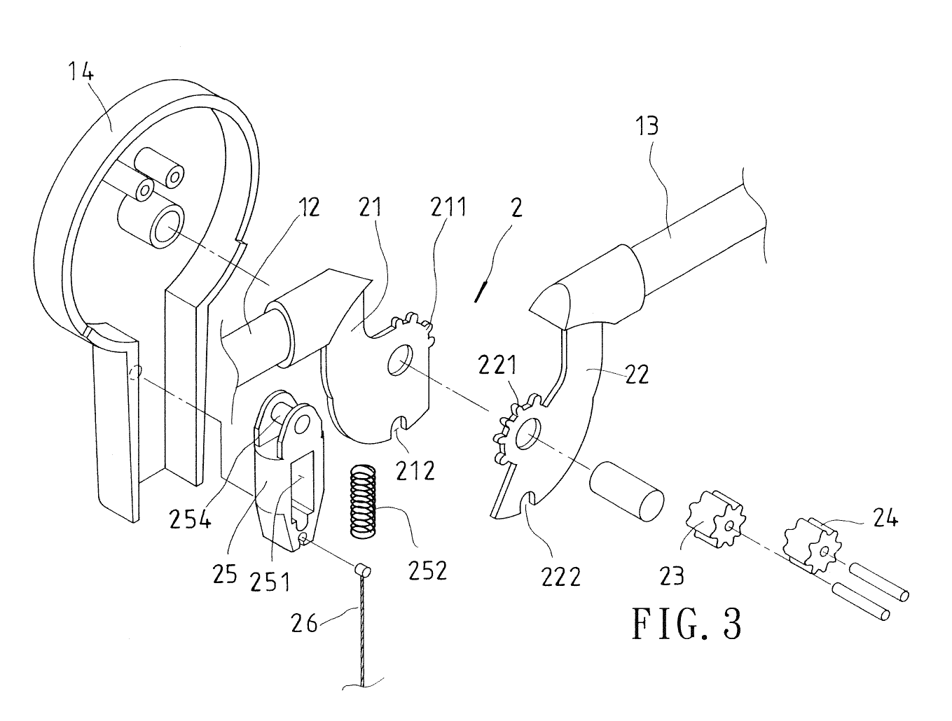

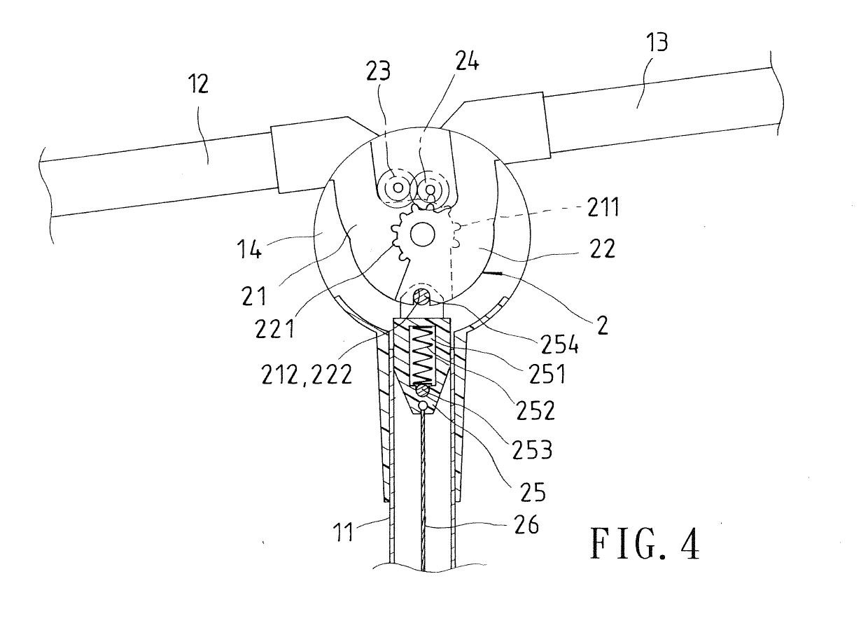

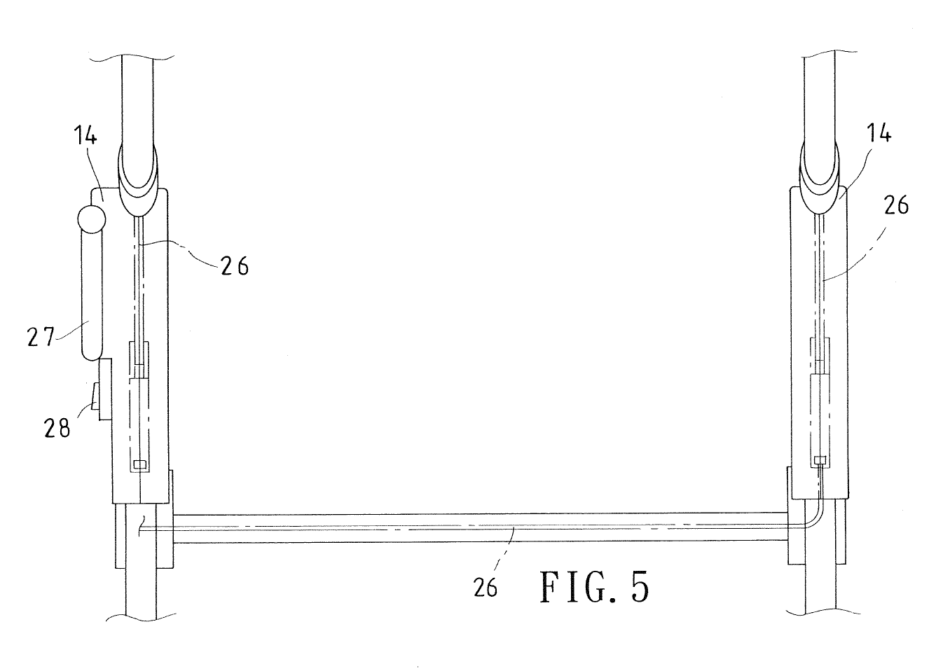

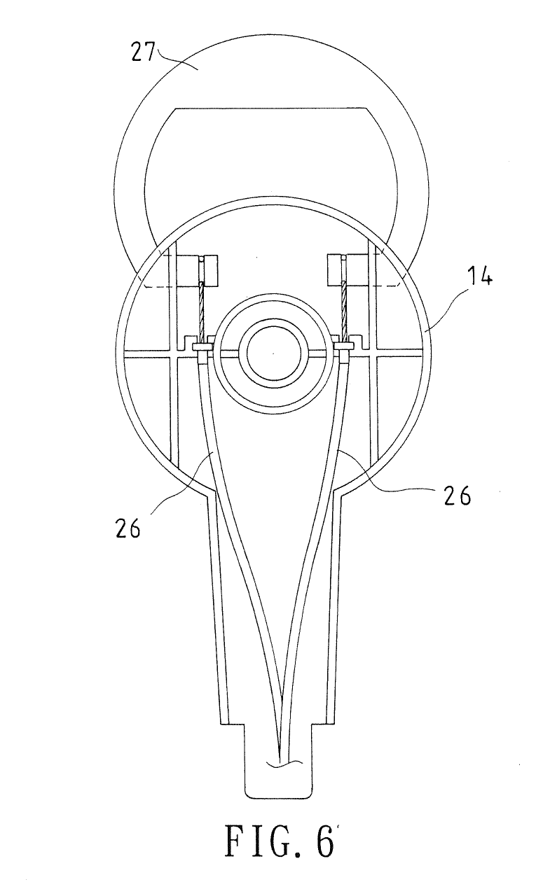

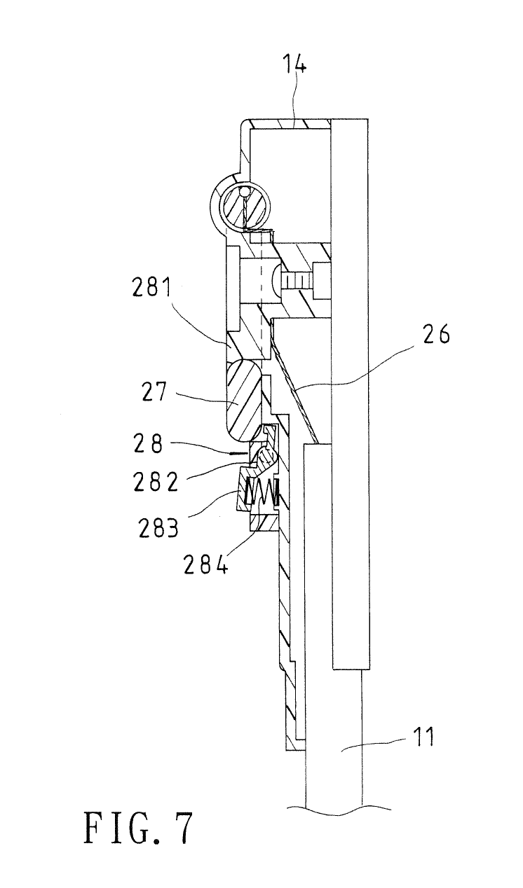

As shown in FIGS. 3 and 4, one of the connection units 14 has the folding device 2 which has a first positioning plate 21 connected to the front frame 12 and a second positioning plate 22 connected to the rear frame 13. The first and second positioning plates 21, 22 are pivotably connected to the connection unit 14. The first positioning plate 21 has first teeth 211 formed along a curved periphery thereof and the second positioning plate 22 has second teeth 221 formed along a curved periphery thereof. The connection unit 14 has a front gear 23 and a rear gear 24 located therein. The front and rear gears 23, 24 are respectively engaged with the first and second teeth 211, 221. The front and rear gears 23, 24 are engaged with each other. The first positioning plate 21 has a first engaging recess 212 and the second positioning plate 22 has a second engaging recess 222. An operation member 25 is received in the connection unit 14 and located beneath the first and second positioning plates 21, 22. The operation member 25 has a hole 251 and a resilient member 252 is located within the hole 251. Two ends of the resilient member 252 are biased between an inner periphery of the hole 251 and a stop member 253 fixed to the connection unit 14. A rod 254 extends from the operation member 25 and is engaged with the first and second engaging recesses 212, 222. The operation member 25 of the folding device 2 is connected to a first end of a cable 26 and a second end of the cable 26 is connected to a driving member 27 which is located outside of the connection unit 14 and connected with the operation member 25 as shown in FIGS. 5 and 6. As shown in FIG. 7, the connection unit 14 has a safety member 28 which has a block 281 protruding from the connection unit 14 and the block 281 is located corresponding to the driving member 27. A push member 282 is pivotably connected to the connection unit 14. The first end of the push member 282 is in contact with the driving member 27 and a button 283 is formed on the second end of the push member 282. A spring 284 is biased between the button 283 and the connection unit 14.

The seat 3 is located between the front and rear frames 12, 13, and two sides of the seat 3 each have a connection member 31. The connection units 14 each have a connection portion 141 and the two connection members 31 are connected with the connection portions 141. The pivotable position between the connection members 31 and the seat 3 has ratchet teeth so as to restrict the seat 3. Each of the connection members 31 of the seat 3 has a first engaging portion 311. A transverse bar 32 is connected between the two connection members 31 and has two second engaging portions 321 which are connected with the first engaging portions 311.

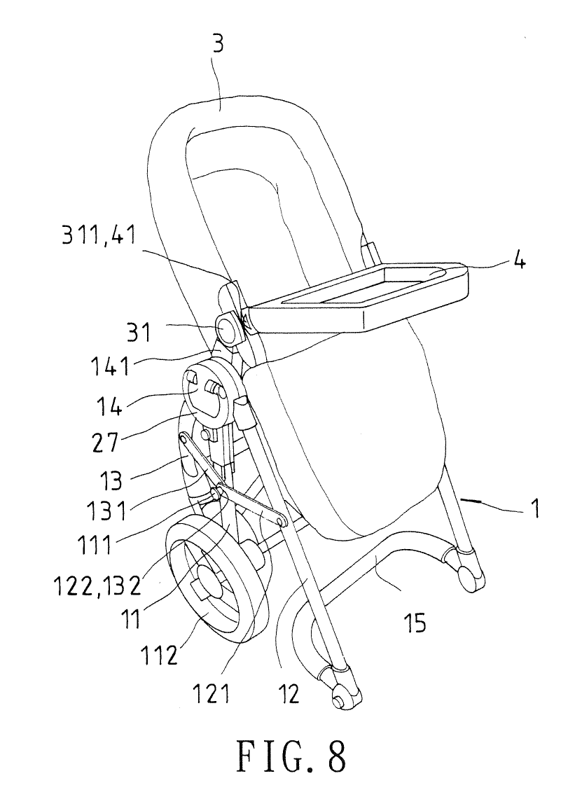

As shown in FIG. 8, the tray support 4 is able to replace the transverse 32 of the seat 3 and has two third engaging portions 41 connected to two sides thereof. The connection members 31 of the seat 3 are connected with the third engaging portions 41.

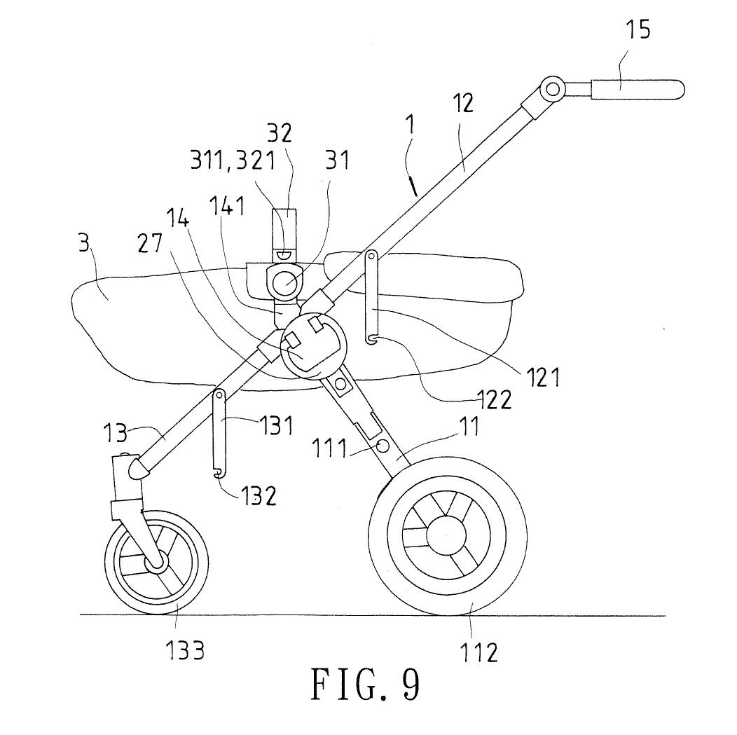

As shown in FIG. 9, when the users want to use the baby stroller 1, the links 121, 131 are separated from the pins 111, and the baby stroller 1 is then expanded by pulling the front and rear frames 12, 13 toward the front and rear ends, the first and second positioning plates 21, 22 are pivoted along with the expansion of the front and rear frames 12, 13 as shown in FIG. 4. The first and second teeth 211, 221 on the first and second positioning plates 21, 22 are moved. By the engagement between the first and second teeth 211, 221 and the front and rear gears 23, 24, the first and second positioning plates 21, 22 are simultaneously moved. The first and second engaging recesses 212, 222 are engaged with the rod 254 of the operation member 25. The resilient member 252 in the operation member 25 pushes the operation member 25 upward when the first and second engaging recesses 212, 222 are engaged with the rod 254 of the operation member 25. Therefore, the front and rear frames 12, 13 are set at the expanded status.

The users then put the baby in the seat 3 and the baby stroller 1 can be moved by the wheels 112, 133. The transverse bar 32 prevents the baby from dropping out from the seat 3. As shown in FIG. 8, when feeding the baby, the transverse bar 32 is removed from the connection members 31 of the seat 3, and the third engaging members 41 of the tray support 4 are engaged with the first engaging portions 311 of the connection members 31 of the seat 3. So that the tray support 4 is secured to the seat 3 and the tray can be put on the tray support 4 for convenience of feeding the baby.

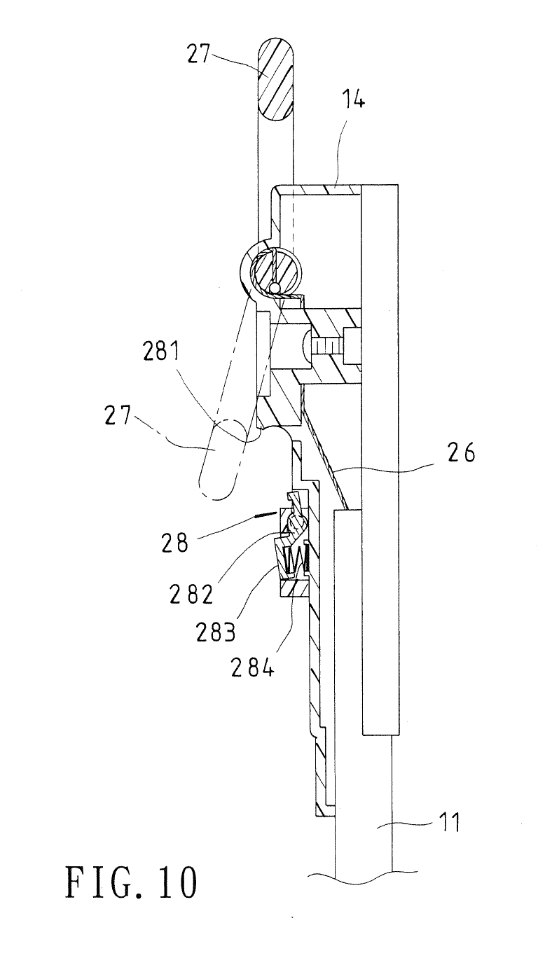

When the users want to fold the baby stroller 1, as shown in FIG. 10, the button 283 on the push member 282 of the safety member 28 of the connection unit 14, the push member 282 then pushes the driving member 27 and the driving member 27 is separated from the block 281 of the connection unit 14. The baby stroller 1 is then unlocked and the push member 282 is released, the spring 284 of the push member 282 pushes the push member 282 back to its initial position.

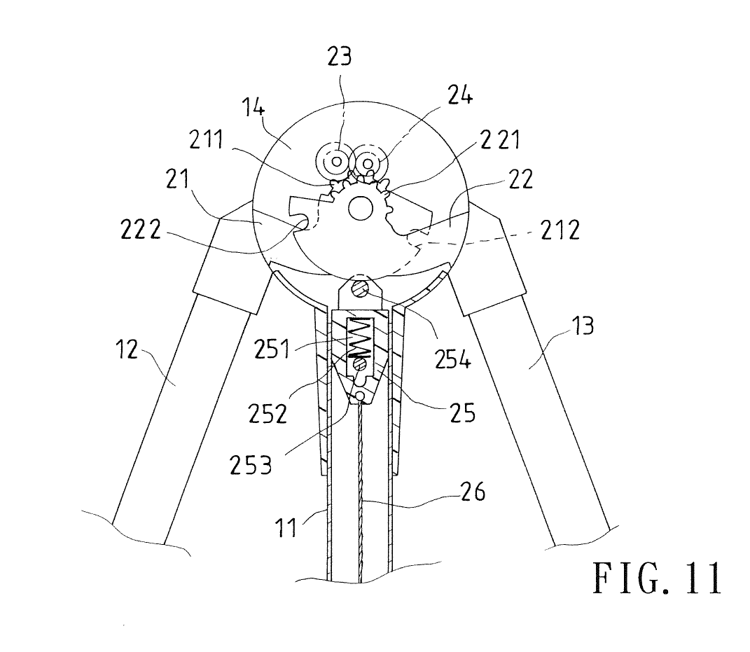

After releasing the safety member 28 from the driving member 27, the users can hold and lift the driving member 27 to pull the cable 26 connected with the driving member 27 as shown in FIG. 11. The operation member 25 connected to the other end of the cable 26 is then moved downward so that the rod 254 is removed from the first and second engaging recesses 212, 222. The users lift the driving member 27, the front and rear frames 12, 13 are pivoted toward the center of the baby stroller 1 due to their own weight. By the engagement between the engagement between the first and second teeth 211, 221 and the front and rear gears 23, 24, the first and second positioning plates 21, 22, and the front and rear frames 12, 13 are simultaneously folded. In other words, the user can fold the baby stroller 1 by one hand. When the baby stroller 1 is folded, the notches 122 and 132 of the links 121 and the links 131 are engaged with the pins 111 of the main frame 11 to set the baby stroller 1 at the folded status.

The folding device 2 is simple and has less number of parts involved, so that the folding device 2 is reliable. Furthermore, thanks to the engagement between the first and second teeth 211, 221 and the front and rear gears 23, 24, the front and rear frames 12, 13 are ensured to be acted simultaneously. The operation of the baby stroller 1 is stable and the safety member 28 maintains the expanded and folded statuses reliable.

While we have shown and described the embodiment in accordance with the present invention, it should be clear to those skilled in the art that further embodiments may be made without departing from the scope of the present invention.

What is claimed is:

1. A baby stroller comprising:
a front frame and a rear frame, the front and rear frames connected to two connection units, one of the connection units having a folding device which has a first positioning plate connected to the front frame and a second positioning plate connected to the rear frame, the first and second positioning plates pivotably connected to the connection unit, the first positioning plate having first teeth and the second positioning plate having second teeth, the connection unit having a front gear and a rear gear located therein, the front and rear gears respectively engaged with the first and second teeth, the front and rear gears being engaged with each other, the first positioning plate having a first engaging recess and the second positioning plate having a second engaging recess, an operation member received in the connection unit and located beneath the first and second positioning plates, the operation member having a rod which is engaged with the first and second engaging recesses, a driving member located outside of the connection unit and connected with the operation member.

2. The baby stroller as claimed in claim 1, wherein the operation member of the folding device has a hole and a resilient member is located within the hole, two ends of the resilient member are biased between an inner periphery of the hole and a stop member fixed to the connection unit.

3. The baby stroller as claimed in claim 1, wherein the operation member of the folding device is connected to a first end of a cable and a second end of the cable is connected to the driving member.

4. The baby stroller as claimed in claim 1, wherein the folding device has a safety member which has a block protruding from the connection unit and the block is located corresponding to the driving member, a push member is pivotably connected to the connection unit, a first end of the push member is in contact with the driving member and a button is formed on a second end of the push member, a spring is biased between the button and the connection unit.

5. The baby stroller as claimed in claim 1 further comprising a main frame located between the front and rear frames, two sides of the main frame being connected to the connection units.

6. The baby stroller as claimed in claim 5, wherein the front frame and the rear frame each have a link, each of the links has a notch, the main frame has pins which are engaged with the notches.

7. The baby stroller as claimed in claim 1 further comprising a seat located between the front and rear frames, two sides of the seat each having a connection member, the connection units each having a connection portion, the two connection members connected with the connection portions.

8. The baby stroller as claimed in claim 7, wherein each of the connection members of the seat has a first engaging portion, a transverse bar is connected between the two connection members and has two second engaging portions which are connected with the first engaging portions.

9. The baby stroller as claimed in claim 8 further comprising a tray support and two third engaging portions connected to two sides of the tray support, the connection members of the seat connected with the third engaging portions.

10. The baby stroller as claimed in claim 7 further comprising a tray support and two third engaging portions connected to two sides of the tray support, the connection members of the seat each having a first engaging portion, the first engaging portions connected with the third engaging portions.
